(19) United States
(12) Patent Application Publication
(10) Pub. No.: US 2017/0247935 A1
(43) Pub. Date: Aug. 31, 2017

(54) Insulating Glass and Method for Manufacturing The Same

(71) Applicant: Jiri Dobrovolny, Prostejov (CZ)

(72) Inventor: Jiri Dobrovolny, Prostejov (CZ)

(21) Appl. No.: 15/506,903

(22) PCT Filed: Aug. 31, 2015
(86) PCT No.: PCT/CZ2015/000100

§ 371 Date: Feb. 27, 2017

(30) Foreign Application Priority Data
Aug. 29, 2014 (CZ) PV 2014-587

(51) Int. Cl. E06B 3/663; E06B 3/673; E06B 3/677; E06B 3/67

(52) U.S. Cl. CPC E06B 3/66366; E06B 3/66314; E06B 3/6715; E06B 3/67326; E06B 3/677

(57) ABSTRACT

Insulating glass unit comprising at least one pair of glass panes and at least one partition member therebetween for dividing the space between the glass panes into insulating chambers, and a spacer (4) which is fixed between the two glass panes (3) along their circumferences and into which the partition member is anchored. The method for manufacturing the insulating glass unit comprises the following steps: a) preparing two glass panes (3) and a partition member, b) preparing a spacer (4) by bending a hollow profile and adapting the inner sides of the spacer (4) for anchoring the partition member to at least two portions of the spacer, c) preparing the partition member, c) anchoring the partition member into the spacer, d) fixing the spacer (4) between the two glass panes (3) so that one side of the spacer circumferentially adjoins the first glass pane (3) and the other side of the spacer circumferentially adjoins the second glass pane (3) and the partition member is straightened and/or tensioned.

### FIELD OF THE INVENTION

The present invention relates to an insulating glass unit comprising at least one pair of glass panes, each such pair being provided with at least one partition member for dividing the space between the glass panes into two or more insulating chambers. Furthermore, the present invention relates to an anchoring element for fixing said partition member and to a method for manufacturing a multi-chamber insulating glass unit.

### BACKGROUND OF THE INVENTION

Known insulating glass units, which constitute the prior art, comprise a film (i.e. a foil) circumferentially fixed between at least two spacers, said film being secured by a circumferential layer of sealant and stretched due to thermal contraction. The film divides the space between the two adjacent glass panes into two or more insulating chambers, thereby improving the heat insulating properties of the respective double glazed unit. The utility model no. 16472 discloses a method for manufacturing such an insulating glass unit. The drawbacks of the above mentioned technical solution consist in that:

using multiple spacers causes a plurality of longitudinal circumferential joints to form; despite the fact that necessary sealing is provided, such joins worsen vapour-proof properties of the insulating glass unit and promote diffusion of technical gases used for filling the space between the glass panes through the marginal areas of such insulating glass unit and simultaneously promote penetration of moisture into the same;
in case that a film comprising a thin metallic layer or a thin layer made of other materials is used, such thin layer can enable the individual gas molecules to penetrate through the area between the vapour barrier and the circumferential sealant, thereby further promoting the above mentioned diffusion of technical gases;
in order to be able to secure the film, i.e. to anchor the same in a stretched state, the circumferentially arranged sealant must have adequate mechanical properties and be sufficiently cured; this requires a technological interruption of the production process, such interruption lasting up to 7 days, thus making the production process substantially longer and more complicated;
the arrangement of multiple spacers in the space between the glass panes poses a risk resulting from the possibility of the mutual displacement of such spacers while being pressed in order to form a package, said displacement subsequently leading to a development of ruptures in the vapour-proof joint and to the occurrence of appearance-related problems when an assembled insulating glass unit is being embedded into a straight frame;
during the process of thermal stretching of a film anchored between two spacers, an excessive pressure builds up inside the space between the glass panes possibly resulting in a damage to the respective insulating glass unit; therefore, the entire insulating glass unit has to be put in a partially open state into a heating device which, again, worsens the properties of such insulating glass unit and which does enable the same to be filled with gas prior to the circumferential application of the sealant; this means that the sealant must be applied in an additional step of the production process following the above mentioned stretching step;
furthermore, it is necessary to use a pair of spacers made of a high-quality material increasing the price of the final product.

### SUMMARY OF THE INVENTION

The above mentioned drawbacks are eliminated by an insulating glass unit comprising at least one pair of glass panes and at least one partition member therebetween for dividing the space between the glass panes into insulating chambers, it further comprises a spacer which is fixed between the two glass panes along their circumferences and into which the partition member is anchored.

Preferably, the partition member is attached to the spacer and straightened or tensioned by means of an anchoring element attached to the circumferential portions of the partition member.

It is also advantageous when those sides of the spacer, which face the hollow space between the glass panes, are provided with a longitudinal groove, into which the anchoring element is embedded.

Preferably, an anchoring element for fixing the partition member in the assembled insulating glass unit is used, which comprises an elastic strip having lateral areas, between which there are arranged an assembling area at one side and a fastening area at the other side, the anchoring element being adapted to be bent along its longitudinal axis causing respective portions of the fastening area to abut each other in order to fasten marginal portions of the partition member.

According to an especially preferred embodiment the assembling area is provided with a pair of grooves extending along the lateral areas, the assembling area being further provided with a reinforcing cover arranged at least in the areas of the grooves and in the area between the grooves and/or the fastening area being provided with an adhesive layer.

It is also advantageous when the assembling area is provided with a rib projecting from the assembling area and extending along the direction of the longitudinal axis of the elastic strip and/or the assembling area or the fastening area is provided with a continuous recess arranged in the central portion of the respective area and intended for achieving a wedge shape of the assembling area after bending the anchoring element along its longitudinal axis.

Drawbacks of prior art are also eliminated by a method for manufacturing the insulating glass unit comprising the following steps:
a) preparing two glass panes and a partition member,
b) preparing a spacer and adapting the inner sides of the spacer for anchoring the partition member to at least two portions of the spacer,
c) preparing the partition member,
d) anchoring the partition member to the spacer,
e) fixing the spacer between the two glass panes so that one side of the spacer circumferentially adjoins the first glass pane and the other side of the spacer circumferentially adjoins the second glass pane and the partition member is straightened and/or tensioned.

Preferably, the longitudinal grooves are milled in the inner sides of the spacer in at least two areas thereof in step b).

According to an especially preferred embodiment, the partition member is an inter-pane film (i.e. a foil), while in step a) the anchoring elements are attached to the edges of the inter-pane film, such that the marginal area of the inter-pane film or an area adjacent to the same passes between the mutually adjoining portions of the fastening area and in step d) the spacer is extended towards the edge of the glass pane during positioning of the spacer, such that the inter-pane film is stretched.

Preferably, the step d) further comprises an operation, which is performed simultaneously with the insertion of the anchoring element into the respective longitudinal groove and which consists in that the hollow space of the spacer containing a partially or fully inserted mounting portion of the anchoring element is filled with a moisture absorber.

Thus, the insulating glass unit according to the present invention comprises a spacer which is secured in that one side of the spacer circumferentially adjoins the first glass pane and the other side of the same circumferentially adjoins the second glass pane and which is adapted for fixing a partition member for dividing the space between the glass panes into separate insulating chambers.

All the known technical solutions constituting the prior art are based on the formation of gas filled insulating chambers by means of multiple spacers. This means that the formation of each chamber requires at least one spacer to be used for delimiting the distance between the respective glass panes along the circumference thereof or for defining the mutual distance of other separating elements.

According to the present technical invention, two or more insulating chambers, which are arranged in the space between two glass panes, are formed by means of a single spacer, said spacer being circumferentially clamped between the glass panes, thereby in a continuous and uniplanar manner enclosing the respective insulating chamber along the circumference of the same. Thus, a single insulating glass unit can comprise more than one pair of glass panes arranged as explained above.

The surface of the above mentioned spacer, which encloses the hollow space between the glass panes along the circumference of the same and which is facing said hollow space, is prepared in a manner enabling a partition member to be anchored therein. Specifically, at least two opposite points/portions of the enclosing surfaces are adapted in the above explained manner, the principle of this technical solution consisting in that the partition member does not pass through the respective spacer into the circumferential sealant.

Simultaneously, the circumferential area of the respective partition member is prepared for being anchored to the above mentioned prepared surface of the spacer. This specifically relates to those portions of the partition member where the latter adjoins the spacer after the final assembly of the unit. When flexibly anchored each to the other, the partition member and the circumferential spacer must be completely straight and adequately tensioned. The present technical solution enables the partition member to be mechanically tensioned in the space between the glass panes. This can be simply accomplished by embedding the partition member into an insulating glass unit comprising a partition member with adequately reduced manufacturing dimensions.

The proposed technical solution eliminates all of the above mentioned drawbacks of prior art because:

only two longitudinal joints, which are provided with vapour-proof seals, are formed along the circumference of the insulating glass unit, thereby eliminating the problem associated with the excessive diffusion of technical gases and, as the case may be, the problem associated the excessive penetration of moisture into the insulating glass unit,
the partition member does not pass through the spacer; this means that gas molecules are prevented from escaping from the hollow space enclosed by a vapour bather when the partition member is provided with a thin metallic layer,
the principle, which consists in stretching the inter-pane member, i.e. the above mentioned partition member, by anchoring it to a spacer enables a desired final straightened and tensioned state to be achieved immediately after embedding the spacer into the respective insulating glass unit
using a single spacer also eliminates all the remaining problems related to the technical solutions constituting the prior art, particularly the problems resulting from the mutual displacement of the spacers, problems associated with heating furnaces or problems associated with the unavoidable additional treatment of the finished insulating glass unit.

### BRIEF DESCRIPTION OF DRAWINGS

The appended drawings show in a schematical manner (and not in a true scale) several exemplary embodiments of the present invention, wherein

FIG. 1 shows an exemplary embodiment of an anchoring element prior to being assembled and

FIG. 2 shows a cross-sectional view of a spacer containing the anchoring element of FIG. 1 inserted therein.

FIG. 3 shows, by way of example, a portion of an insulating glass unit manufactured using the method according to the present invention,

FIG. 4 shows a portion of a spacer in a perspective view,

FIG. 5 shows an example of preparation of inter-pane films by cutting the same,

FIG. 6 shows a preferred embodiment of a corner portion of the prepared inter-pane film,

FIG. 7 shows a film with an indication of bending to be performed before inserting the film into an anchoring element,

FIG. 8 schematically explains the process of filling the space between glass panes with gas,

FIG. 9 is a cross-sectional view showing a spacer in the course of the process of inserting the anchoring element into a longitudinal groove, the hollow space inside the spacer being simultaneously filled with an absorber,

FIG. 10 schematically shows the process of attaching the spacer to a glass pane, the spacer being simultaneously stretched,

FIG. 11 is a partial perspective view showing another embodiment of the spacer,

FIG. 12A is a schematical side view showing the spacer of FIG. 11 prior to being bent,

FIG. 12B is a similar schematical view showing a profile prepared for being used during the manufacture of a spacer composed of multiple individual parts, and

FIG. 13 shows a corner portion of a film prepared for being fixed in the frame of. FIG. 11.

### DESCRIPTION OF EXEMPLARY EMBODIMENTS

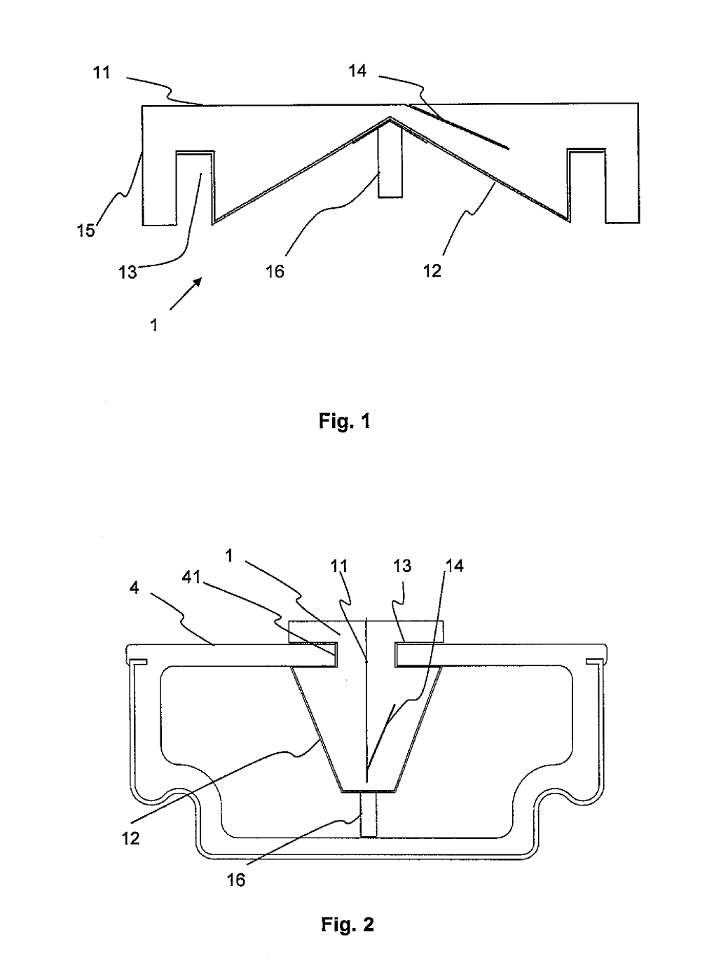

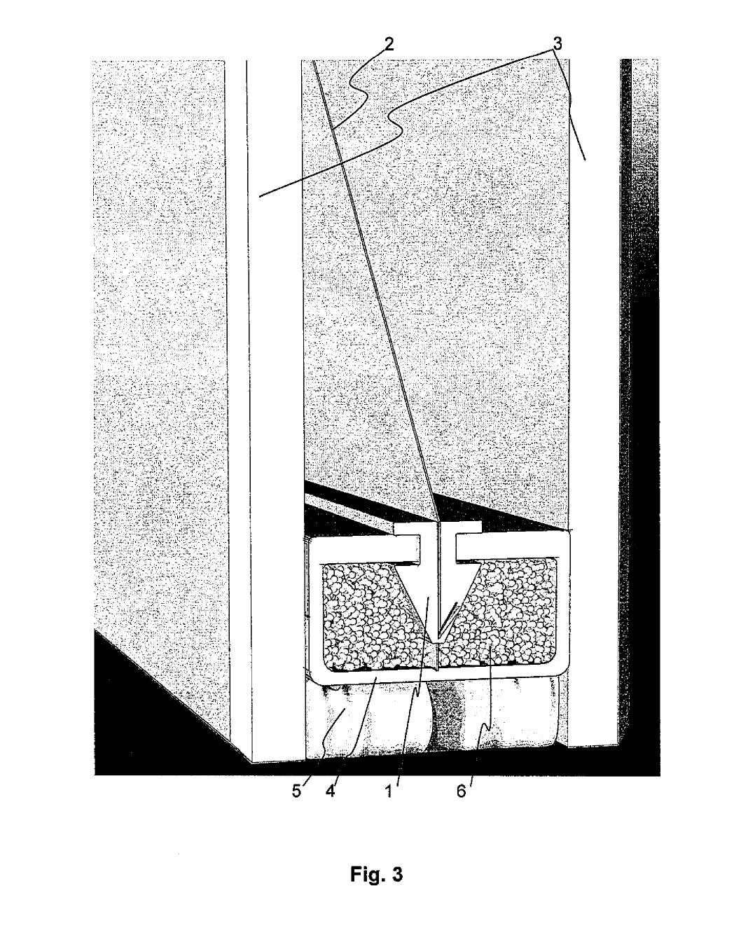

FIG. 1 shows an exemplary embodiment of an anchoring element 1 prior to being assembled. The anchoring element 1 is made of an elastic material, such as silicone, EPDM or another polymer-based or rubber based material having an adequate UV stability. The anchoring element has the form of a strip having a fastening area 11 on its one side and a profiled assembling area 12 on its other side, the latter area being provided with two grooves 13 spaced from the lateral sides 15 of the strip. The thickness of the strip gradually decreases in the direction from the grooves 13 towards the central portion of the strip. In other words, the central portion of the profiled assembling area 12 of the strip is provided with a continuous recess prior to the final assembly. The recess has a V shape. However, other shapes are also conceivable which means, for example, that both sides of the recess can have symmetrical concave or convex shapes, or asymmetrical shapes.

In a preferred embodiment, the assembling area 12 is provided with a reinforcing jacket 17 arranged at least in the areas of the grooves 13, such jacket being composed, for example, of a film made of a polymer or metallic material.

In another preferred embodiment, the central portion of the assembling area 12 is provided with a rib 16 projecting from the assembling area 12 and extending along the lengthwise direction of the strip corresponding to the direction of the longitudinal axis of the anchoring element 1.

The fastening area 11 of the strip is provided with a fastening slot 14 which extends in an oblique direction with respect to the plane of the fastening area 11 in the present embodiment. However, said fastening groove may also extend perpendicularly to the plane of the fastening area 11.

Preferably, the fastening area 11 is provided with an adhesive layer for securing the marginal area of the inter-pane film 2. As clearly illustrated in FIG. 2, the anchoring element 1 is bent during the process of assembly. Thereby, the fastening area 11 is folded and the outer surface of the bent anchoring element is formed by the exposed assembling area 12 and by the lateral areas 15, the lateral areas 15 being situated in a common plane. This bending process causes the recess of the assembling area 12 to assume the form of a continuous wedge-shaped element which comprises the grooves 13 arranged on either side thereof and situated in a common plane. Simultaneously, the marginal area of the inter-pane film is clamped between the adjoining areas of the fastening area 11.

Hereinafter, a method for producing an insulating glass unit will be explained, said glass unit comprising the above described anchoring element 1 for fixing the inter-pane film 2 between two glass panes 3.

A suitably selected type of a spacing profile is bent in order to assume a defined shape, such as a rectangular one, corresponding to the desired shape of the spacer 4. It is a matter of course that the method according to the present invention is also applicable to insulating glass units and/or spacers having different shapes, such as arched shapes, triangular shapes or the like. Subsequently, the spacer 4 is provided with two pairs of holes drilled on one side of the frame and having the diameters of about 3 mm. Then, the holes are provided with bushings (not shown) inserted thereto, said bushing being made of a plastic material or another suitable material and intended for facilitating a later step of filling the hollow spaces between the glass panes with gas.

Preferably the width of the profile or that of the spacer 4 ranges between 8 and 40 mm. After having been prepared in the manner explained above, the spacer 4 is provided with longitudinal grooves 41 on its straight sides. The longitudinal grooves, which have e.g. about 2 mm in width, can be formed by means of a milling cutter or another suitable tool. Typically, the longitudinal groove 41 will be situated in the central portion on that side of the profile which has the smallest dimension and which will remain visible in the finished insulating glass unit (i.e. the side facing the hollow space between the glass panes). In case that multiple films are arranged between the glass panes, the longitudinal groove 41 can also extend outside the central line of the respective side of the profile and the total number of the longitudinal grooves will be equal to that of the films. Preferably, the longitudinal groove 41 does not pass through the corner portions but only extends along the straight sides of the profile of the spacer 4. Thereby, it will be ensured that the shapes of the corners of the spacer remain unchanged.

The inter-pane film 2 is cut, e.g. by means of a plotter or another suitable device enabling the inter-pane film 2 to be held in a fixed position while being cut (such a vacuum fixture comprising a support plate provided with multiple holes acting as suction caps). At the same time, any relative displacement of the film and the support plate should be prevented (e.g., in that the support plate will carry out a simultaneous movement with the inter-pane film 2) in order to protect the film from getting scratched. Contrarily, if it is necessary to adjust the position of the inter-pane film 2 relative to the support plate, a suitable air cushion can be used. Such an air cushion can be formed by forcing air into the above mentioned holes arranged in the planar area of the support plate.

During the process of cutting the inter-pane film 2, the intermediate portions 22 of the original film are notched in order that they can be torn off and removed from the planar area in the subsequent stage (FIG. 5). The respective notches are indicated by the reference numeral 23.

An example of a particularly preferred shape of a corner portion of the inter-pane film 2 prepared by cutting is shown in FIG. 2. Substantially, the inter-pane film 2 consists of a basic portion (typically a rectangular one) having a shape matching with that of the glass panes 3. However, the dimensions of said basic portion are slightly smaller in order to enable the inter-pane film 2 to be adequately stretched by the assembled spacer 4. The basic portion of the inter-pane film 2 is supplemented with auxiliary marginal portions intended for being attached to the anchoring element 1. The ends of said marginal portions are spaced from the corners of the basic portion. The outside corners of the basic part are provided with rounded projections which will engage with the inside corner areas of the spacer 4 in the finished insulating glass unit.

After obtaining the desired shapes of the film, a special tool attached to the “working head” of the plotter is used to successively form a fold 21 having about 2 mm in width along the straight sides of the film, except for the corner areas of the same. In the course of this step, the film is held by means of the suction holes, thereby remaining in a defined fixed position with respect to the X/Y-coordinate system. The individual stages of the process of forming the fold 21 are indicated in FIG. 7. In stage (1), the inter-pane film 2 is flat after having been cut out; in stage (2), one of the marginal portions of the film is lifted; in stage (3), the lifted marginal portion of the inter-pane film 2 assumes a position in which it is perpendicular to the remaining area of the film; and in stage (4), the fold 21 is already formed, the edge of said fold adjoining the central area of the inter-pane film 2. Thereby, an acute angle is included between the fold and the central area of the film. This is accomplished by means of a special tool assembly travelling along exactly defined paths extending in the marginal areas of the inter-pane film 2. Such special tool assembly may consist, for example, of the following components arranged on the working head in a linear succession:

a thin, flat polished L-shaped tool travelling along a support plate and scooping the inter-pane film 2,
a bending roller travelling exactly along the bend line and serving for forming a partial indentation, on the one hand, and for supporting the bending area, on the other hand,
a bending tool for pushing the preliminary fold 21 against the roller,
an “ironing device” for forming a permanent fold 21 in the marginal area of the inter-pane film 2.

Subsequently, a special tool attached to the “working head” of the plotter is used for embedding the anchoring element 1 into all the straight sides of the inter-pane film 2 and/or for inserting the lateral folds 21 of the inter-pane film 2 into the fastening slot 14, the inter-pane film 2 being held by means of suction holes and thereby remaining in a fixed position with respect to the X/Y-coordinate system. The anchoring element 1 can be provided in the form of an endless coil situated outside the cutting device or, preferably, over the latter. Thus, the anchoring element can be gradually unwound and fed into the embedding tool in accordance with the respective requirements of the “working head”. The embedding tool in itself can preferably comprise multiple components arranged in a linear succession downstream of the feeding path, such as:

a pair of guiding rollers provided with lips for guiding the anchoring element 1 bilaterally into the locations where the anchoring element will be embedded into the respective groove formed in the profile by milling,
a central roller provided with a lip and working independently from the current height adjustment, said central roller being intended for gaping the fastening slot 14,
a lateral roller intended for pushing the anchoring element 1 through the fastening slot 14 onto the fold 21 of the inter-pane film 2 in a defined manner,
a roller for pushing the anchoring element 1 against the support plate in the vertical direction and for thereby ensuring an appropriate adhesion of one half of the anchoring element 1 to the inter-pane film 2, said roller being supplemented with a parallel one for lifting the second half of the anchoring element 1 in order to prevent that second half from adhering to the support plate
a roller array wherein the individual rollers successively lift the anchoring element 1 including the film partly glued thereon and then progressively fold the anchoring element 1 in order to push it against the opposite side of the film.

In order to perform its function in a correct manner, the entire assembly must be operated not only in the X/Y coordinate system but also in the Z-direction. During this process, all the edges of the inter-pane film are successively provided with the auxiliary elastic anchoring element 1. The above roller can be pushed and guided by a feeding/travelling mechanism working in the directions (X/Y), Z and by the working head which performs a swivelling motion. Moreover, various compression springs, pushing elements, etc. can be used, such elements being actuated by being brought into contact with the support plate of the cutting unit, with the anchoring element 1 or with the inter-pane film 2

Preferably, the feeding path also comprises a device for metering and cutting the anchoring element 1 to a desired length corresponding to the shape of the inter-pane film 2. When thus prepared, the inter-pane film 2, including the anchoring element 1 embedded and glued therein, is transferred by means of an air cushion from the cutting and embedding location to the free part of the working area of the plotter where it is lifted end held by means of the integral anchoring element 1 in order to be vertically hung on a hook of a feeder. Thereby, dust will be prevented from settling on the surface of the film.

When assuming a hung state, the inter-pane film 2 will be temporarily attached to the prepared spacer 4 (e.g., by means of suitably adapted hand-operated spring pins or clamping bolts) in order to continue to form an integral part of the assembly. Thus, the assembly can be handled in its entirety when the spacer 4 is held by an operator.

After having been prepared in the manner explained above, the assembly is put on a moving belt so that the first side of the former adjoins the surface of the latter. The operator keeps on holding the assembly because the vertical orientation of the same must be retained. Then, the spacer 4 including the inter-pane film 2 temporarily attached thereto is pushed by means of a moving belt against the following tool set:
a tool for gaping the longitudinal groove 41 in the spacer 4 in a bilateral manner
a tool for guiding the anchoring element 1 along with the inter-pane film glued thereto, said tool being intended for pushing the anchoring element 1 towards an exactly defined location in the longitudinal groove 41 formed in the spacer 4 by milling,
a tool for guiding two thin tubes following the embedded anchoring element 1, said tubes being intended for filling the cavities formed in the spacer 4 with a moisture absorber 6.

After finishing every individual side, this process is repeated for the next side. In the course of this process, an operator manually turns the spacer 4 along with the inter-pane film 2 and with the anchoring profile element 1 in order to successively make the individual sides accessible for being brought into the “zero” position. Before putting the belt into motion, the temporary fixing clamps arranged on the working side are removed in order that they do not hinder the anchoring element 1 from being embedded. When thus prepared, the spacer 4 containing the inter-pane film 2 embedded therein is vertically hung in a feeder in which a supply of components needed for the manufacture of insulating glass units is maintained in a specified order.

Afterwards, a thin flat layer of butyl is deposited on the lateral sides of the spacer 4. In contrast to the standard arrangement, the manufacturing equipment will have to be adapted in order to be able to accommodate and process the subassembly comprising the anchoring element 1 and the inter-pane film 2 embedded therein. Such an adaptation mainly relates to an adjustment of the pressure used for pushing the spacer 4 against the moving belt. This means that the pressure rollers must be arranged in pairs and able to symmetrically exert uniform pressures acting on the free marginal surfaces of the profile (i.e. not centrally, in contrast to the prior art).

Subsequently, one washed up and dried glass pane 3 is brought into the vertical position and then slightly tilted towards the embedding zone of the spacer 4 including the inter-pane film 2. The glass pane 3, the spacer 4 as well as the inter-pane film 2 have exactly defined dimension. Thereby, the inter-pane film 2 can be adequately smaller compared to the spacer 4. The same applies to the dimensional relationship between the spacer 4 and the glass pane 3. The process, during which the spacer 4 is successively embedded into the individual sides of the respective glass pane, stretched and glued to a butyl layer, a “controlled” disproportion of the dimensions of the individual components occurs, causing the inter-pane film 2 to be tensioned inside a corresponding auxiliary elastic profile. In this stage, it is important to ensure that the profile is correctly located. This can be accomplished by means of auxiliary fixtures exerting an adequate pressure acting on the butyl layer. Preferably, the respective pane is warm during this stage. An increased temperature of the pane can be obtained by preheating the air used for drying and by using warm water in the washing zone.

Thereby, the inter-pane film 2 is stretched in a simple way which does not require a separate step. Instead, the film is stretched during a common manufacturing process comprising a step of anchoring a spacer 4 to a glass pane 3. The hardness of the elastic spacer 4, to which the inter-pane film 2 is anchored, should be suitably selected so that the force being exerted does not exceed the adhesion strength of the joint between the spacer 4 and the butyl layer. On the other hand, that force should enable an adequate tension to be exerted in order that the inter-pane film 2 remains permanently stretched and that length variations, which have been caused by the thermal expansion of the individual parts of the insulating glass unit, can be eliminated.

Subsequently, the second glass pane 3 of those forming the concerned pair of glass panes is embedded and both the glass panes 3 are pressed to each other and pushed against the spacer 4 provided by a butyl layer applied to the other side thereof. Thereby, the butyl layer becomes adequately flattened in order to provide the function of a vapour bather and to enable the chambers between the individual glass panes 3 and the inter-pane film 2 to be filled with a technical gas (such as argon). Simultaneously, the circumferential area between the spacer 4 and the pair of glass panes 3 can be filled up with the sealant 5. Suitable materials for sealant 5 include, for example, hot melts, PUR, polysulphides or silicones.

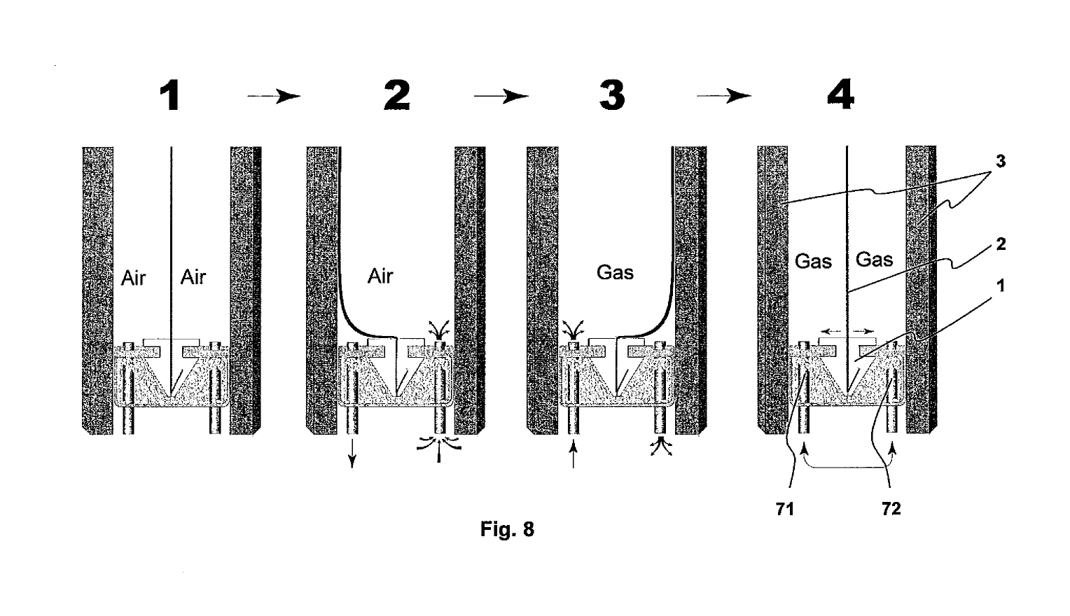

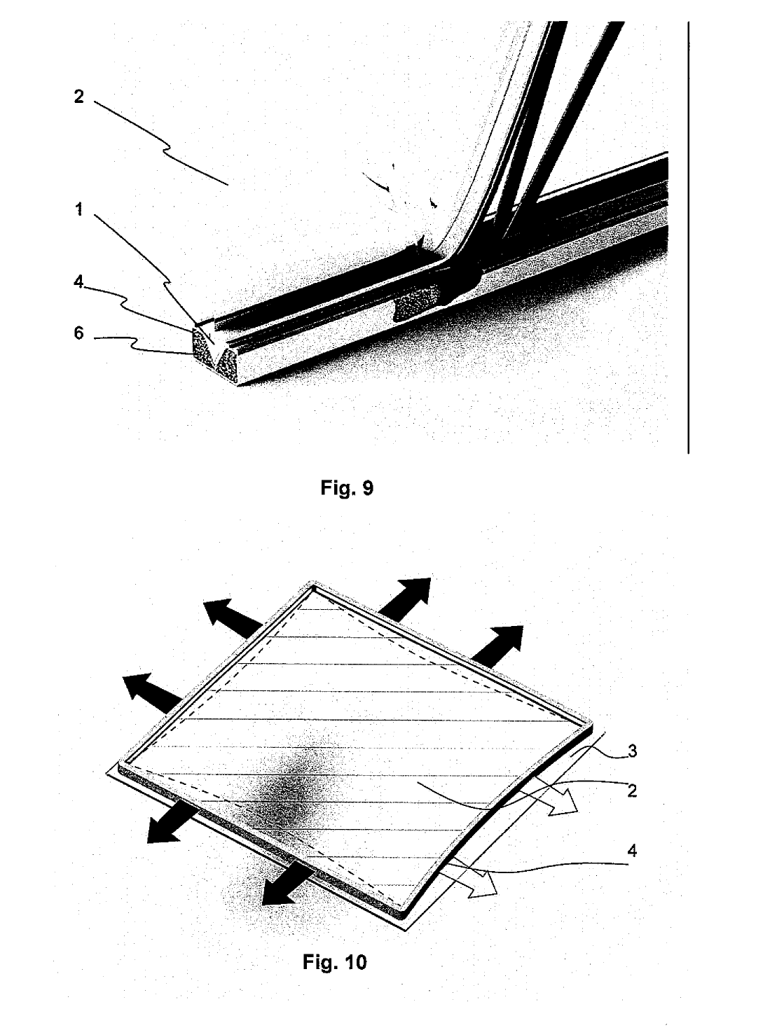

The process of filling the chambers formed between the glass panes 3 and the inter-pane film 2 with a technical gas, which is indicated in FIG. 8, is carried out as follows:

In the stage (1), the insulating glass unit is prepared for being filled. The chambers arranged between the glass panes 3 and the inter-pane film 2 are filled with air. In the stage (2), the first filling needle 71 connected to a vacuum pump is used for exhausting air from the first chamber (the left-hand one, as illustrated in FIG. 8). Thereby, a vacuum state is obtained causing the inter-pane film 2 to adjoin the first glass pane 3. Simultaneously, the second chamber is filled with air supplied by means of the second filling needle 72. In the stage (3), the exhausted first chamber is gradually filled with a technical gas by means of the first filling needle 71 until the inter-pane film 2 adjoins the second glass pane 3. Simultaneously, the air contained in the second chamber is displaced therefrom through the second filling needle 72. Preferably, the second chamber is being exhausted while the first one is being filled. Thus, the filling and exhausting processes can be controlled in a synchronous manner. In the stage (4), the filling needles 71, 72 are pulled out and the inflating orifices are plugged. The existence of the leaks in the corner areas of the individual chambers cause the pressures acting in the adjacent chambers to gradually equalize. Simultaneously, the inter-pane film 2 spontaneously assumes its original position in the central zone of the hollow space between the glass panes 3 due to the elastic tensioning action of the anchoring element 1. Additionally or alternatively, the filling needles 71, 72 can be interconnected after closing their inlets in order to equalize the gas volumes in the adjacent chambers.

This process is preferably based on the favourable properties of the inter-pane film 2 which consist in that the latter can be, in contrast to glass, bent and formed in a defined manner and in that the same can be stretched when elastically clamped. This means that the film can be temporarily deep drawn and thereby one of its edges can be pulled into a respective clamping area. It is important to maintain appropriate differences between the gas pressures, during which high/satisfactory exhausting and filling levels are achieved, but which cannot cause the inter-pane film 2 or the elastic bed of the same to be damaged due to any pressure effects. The rib projecting from the assembling area 12 of the anchoring element 1 divides the inner hollow space of the spacer 4 in two parts, said two parts being mutually sealed, although not in a fully impervious manner. The process of filling the space between the glass panes 3 with gas is so rapid that no significant pressure equalization occurs during the stages 2 and 3. Contrarily, the pressures inside the individual chambers of the inter-pane space will equalize due to the elastic attachment of the inter-pane film 2 as well as due to the imperfect tightness of the above mentioned two areas of the hollow space inside the spacer. Thereby, the inter-pane film 2 becomes stretched to such an extent that it divides that hollow space into two chambers (stage 4).

This filling process is particularly favourable because of being easy and fast and because of saving the costs related to the gas consumption.

During the subsequent steps of the process, a special way of fixing the spacer 4 can be used until the circumferential sealant 5 becomes completely cured in order to prevent the letter from being shifted in the direction of the tensional force acting on the inter-pane film 2. This can be achieved by using a pair of oppositely arranged flat magnets, e.g. round ones, each magnet being located in the centre of the surface of the respective one of the two glass panes 3. The overpressure, which is caused by the magnetic force acting between the above mentioned magnets, pushes the spacer 4 in a direction which is opposite to that of the force tensioning the inter-pane film 2. After curing the sealant 5 and placing the pre-assembled insulating glass unit into transport racks, the magnets are removed, thereby becoming usable for the next assembly.

It is a matter of course that the method for manufacturing an insulating glass unit according to the present invention is also usable for multi-chamber insulating glass units where three or more glass panes 3 are used and where a spacer 4 along with an inter-pane film 2 and an anchoring member 1 are arranged between at least two of those glass panes, as described above. Theoretically, the spacer 4 can be also provided with a pair of parallel grooves 41 extending along each side thereof and to install two mutually parallel inter-pane films 2 into a common, single spacer.

The inter-pane film 2 can be replaced by another partition member, such as a membrane, a woven or non-woven fabric or, in general, a plastic or metallic sheet. Theoretically, the partition member can be also made of glass and embedded, e.g., into a pair of oppositely arranged longitudinal grooves 41 formed in the spacer 4 by milling.

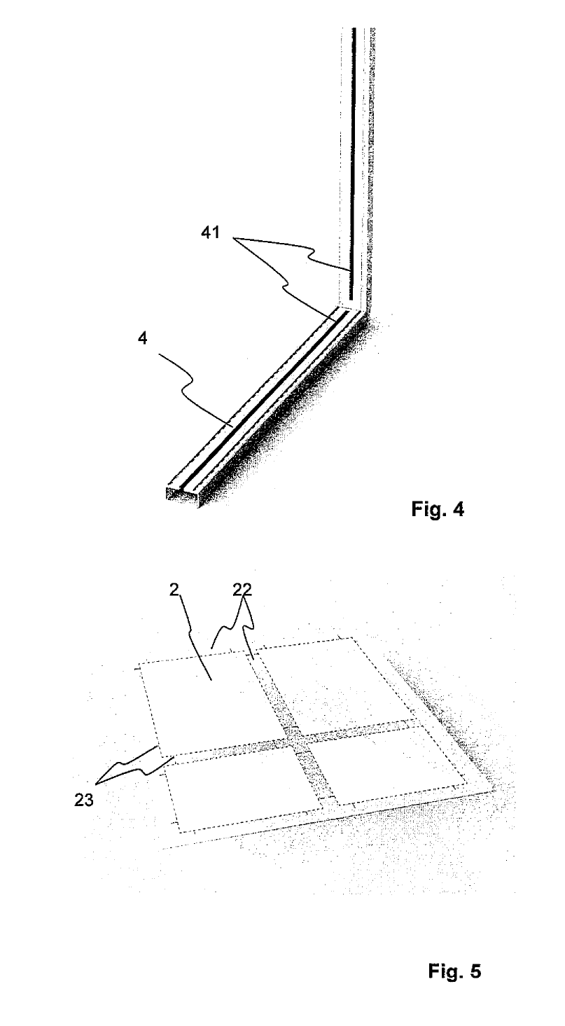

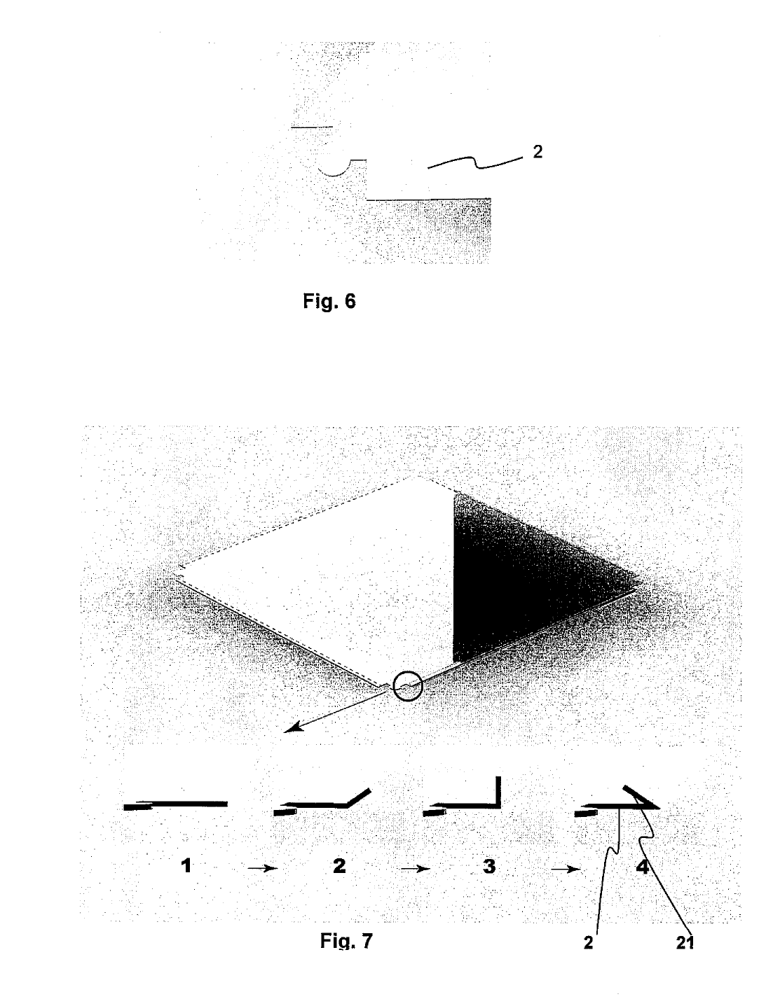

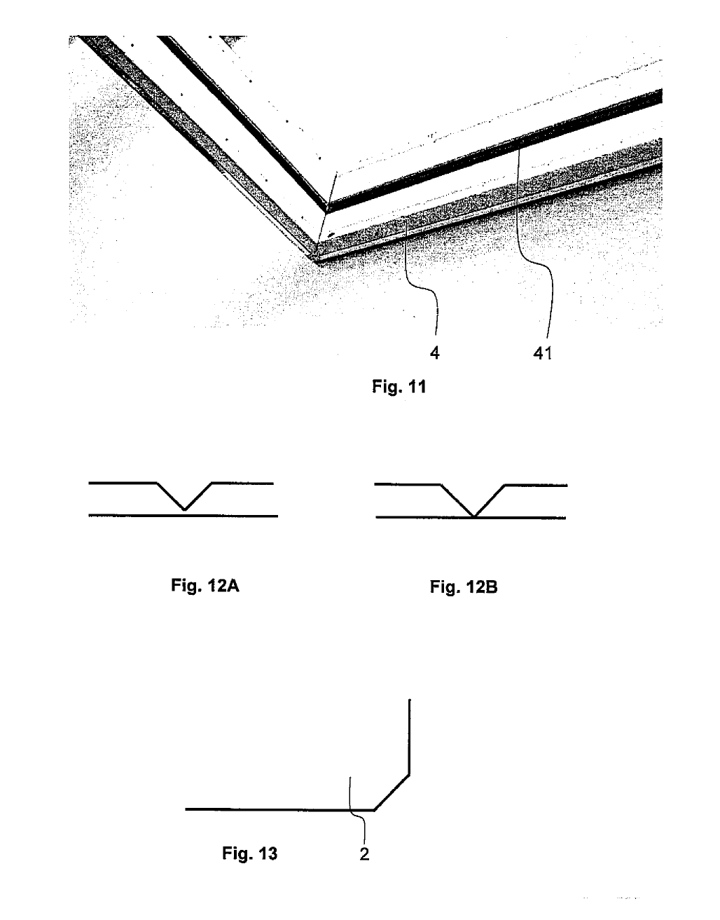

As already mentioned above, the present invention is applicable to different types and shapes of insulating glass units of spacers 4. FIG. 11 shows a spacer 4 which is different from the spacer 4 shown in FIG. 4 in that the longitudinal groove 41 continuously extends in the corner areas, as well. This can be achieved in that the profile used for manufacturing the spacer 4 is provided with a wedge-shaped cut-out formed by milling on the inner side in the intended location of the fold, said wedge-shaped cut-out having a defined depth and the shoulders of the same being perpendicular to each other. As illustrated in FIG. 12A, the value of the angles formed between the shoulders of the wedge-shaped cut-out and the respective surfaces of the profile is 45°. The outer side of the profile (i.e. the bottom one, as shown in FIG. 12A) remains undivided. Subsequently, the profile used for the manufacture of the spacer is bent along a given line. The sides of the wedge-shaped cut-out, which will mutually adjoin due to the bending action, can be glued each to the other (e.g., when the frame is made of a plastic material), or joined together by soldering (when the frame is made of steel), or joined together by heat welding (again, when the frame is made of a plastic material). The above mentioned angular values apply to a rectangular spacer. In case of a different shape of the spacer, the respective angular values can be adapted accordingly. The shape of a corner portion of a film 2, which is suitable for the latter type of a spacer, is shown in FIG. 13.

In another alternative embodiment, a wedge forming a right angle is milled into the profile through the whole depth of the same (FIG. 12B). Thereby, separate parts for assembling a spacer 4 are obtained. In other words, multiple individual sides of the spacer 4 being manufactured using the method according to the present invention are formed, said sides having their ends tapered at an angle which substantially corresponds to one half of the angle included between two adjacent parts of the spacer 4. Subsequently, the individual parts are joined. The advantage of this embodiment consists in that the anchoring element 1 can be embedded into the longitudinal groove 41 more easily. Again, a film 2 having its corner areas adapted according to FIG. 13 is usable for the finished spacer 4. With regard to the general principle of the present invention, the embodiments described above should be considered to be only illustrative ones. Those skilled in the art would surely appreciate further possible alternatives to and modifications of the particular technical solutions and details described herein. Hence, the scope of the present invention is limited solely by the appended claims ant not by the particular details contained in the description and explanation of the individual preferred embodiments.

1-11. (canceled)

12. Insulating glass unit comprising at least one pair of glass panes, at least one partition member in the form of an inter-pane film therebetween for dividing the space between the glass panes into insulating chambers, and a spacer which is fixed between the two glass panes along their circumferences and into which the partition member is anchored, wherein the partition member is attached to the spacer and tensioned by means of an anchoring element attached to the circumferential portions of the partition member characterized in that the anchoring element comprises an elastic strip having—in its pre-assembly state—lateral areas, between which there are arranged an assembling area at one side and a fastening area at the other side, the anchoring element being in its assembled state bent along its longitudinal axis causing respective portions of the fastening area to abut each other in order to fasten marginal portions of the partition member therebetween.

13. Insulating glass unit according to claim 12, wherein those sides of the spacer, which face the hollow space between the glass panes, are provided with a longitudinal groove, into which the anchoring element is embedded.

14. Insulating glass unit according to claim 12, wherein the assembling area is provided with a pair of grooves extending along the lateral areas, the assembling area being further provided with a reinforcing jacket arranged at least in the areas of the grooves and in the area between the grooves and/or the fastening area being provided with an adhesive layer.

15. Insulating glass unit according to claim 12, wherein the assembling area is provided with a rib projecting from the assembling area and extending along the direction of the longitudinal axis of the elastic strip and/or the assembling area or the fastening area is provided with a continuous recess arranged in the central portion of the respective area and intended for achieving a wedge shape of the assembling area after bending the anchoring element along its longitudinal axis.

16. Method for manufacturing the insulating glass unit according to claim 12, said method comprising a step of
a) preparing two glass panes and a partition member in the form of an inter-pane film,
b) preparing a spacer and adapting the inner sides of the spacer for anchoring the partition member to at least two portions of the spacer,
c) anchoring the partition member to the spacer by means of anchoring elements attached to the edges of the inter-pane film,
d) fixing the spacer between the two glass panes so that one side of the spacer circumferentially adjoins the first glass pane and the other side of the spacer circumferentially adjoins the second glass pane and the partition member is tensioned,
wherein, characterized in that in step a) the anchoring elements are attached to the edges of the inter-pane film, such that the marginal area of the inter-pane film or an area arranged adjacent to the same passes between the mutually adjoining portions of the fastening area and in step d) the spacer is extended towards the edge of the glass pane during positioning of the spacer, such that the inter-pane film is stretched.

17. Method for manufacturing according to claim 16, wherein in step b) the spacer is prepared by bending a hollow profile.

18. Method according to claim 16, wherein in step b) longitudinal grooves are milled in the inner sides of the spacer in at least two areas thereof.

19. Method according to 16, wherein the step d) further comprises an operation, which is performed simultaneously with the insertion of the anchoring element into the respective longitudinal groove and which consists in that the hollow space of the spacer containing a partially or fully inserted mounting portion of the anchoring element is filled with a moisture absorber.
